(19) United States
(12) Patent Application Publication
(10) Pub. No.: US 2022/0391131 A1
(43) Pub. Date: Dec. 8, 2022

(54) COMPUTER-READABLE RECORDING MEDIUM, INFORMATION PROCESSING DEVICE CONTROL METHOD AND INFORMATION PROCESSING DEVICE

(71) Applicant: FUJITSU LIMITED, Kawasaki-shi (JP)

(72) Inventors: Reika KINOSHITA, Kawasaki (JP); Satoshi Imamura, Kawasaki (JP)

(73) Assignee: FUJITSU LIMITED, Kawasaki-shi (JP)

(21) Appl. No.: 17/710,028

(22) Filed: Mar. 31, 2022

(30) Foreign Application Priority Data
Jun. 4, 2021 (JP) 2021-094226
Jan. 13, 2022 (JP) 2022-003767

(51) Int. Cl. G06F 3/06

(52) U.S. Cl. CPC G06F 3/0655; G06F 3/0604; G06F 3/0673

(57) ABSTRACT

An information processing device 1 acquires the total number of rewriting times for each of modules of persistent memories (PMEM), and acquires the number of times a specific file is rewritten based on the numbers of times respective pages of PMEMs 301 to 303 are rewritten, and when the number of times the specific file is rewritten is equal to or larger than a transfer threshold, transfers the specific file to a module with a first total number of rewriting times that is smaller than a second total number of rewriting times of a source module in which the specific file is stored.

### CROSS-REFERENCE TO RELATED APPLICATIONS

This application is based upon and claims the benefit of priority of the prior Japanese Patent Application No. 2021-094226, filed on Jun. 4, 2021 and the prior Japanese Patent Application No. 2022-003767, filed on Jan. 13, 2022, the entire contents of which are incorporated herein by reference.

### FIELD

The embodiments discussed herein are related to a computer-readable recording medium, an information processing device control method and an information processing device.

### BACKGROUND

Persistent memories (PMEM) have appeared recently and use of a persistent memory as a non-volatile main memory with a large capacity is drawing attentions. Durability of a PMEM to rewriting is lower than that of a dynamic random access memory (DRAM). For example, it is said that, while the rewrite life of a DRAM is 10¹⁵ cycles, the rewrite life of a PMEM is 10⁸ cycles.

For example, there is the following hardware configuration as a hardware configuration of an information processing device using a PMEM. A plurality of PMEM DIMMs (Dual Inline Memory Module) are connected to a single central processing unit (CPU). A monitoring device that is referred to as a hardware performance monitoring counter (PMC), a memory controller, etc., are installed in the CPU. The PMC counts the number of events of hardware that are executed. Furthermore, the PMC is capable of counting the number of times the PMEM is rewritten.

For example, in some cases, PMEM DIMMs are used as individual PMEM devices without interleaving. An application that is run by the CPU accesses bytes of each PMEM according to a load command or a store command. In this case, the application directly accesses the PMEM not via a file system of an operating system (OS).

Using the PMEM DIMMs without interleaving as described above has the following advantages. One of the advantages is that physically separating the PMEM DIMMs that are assigned to processes enables an increase in operation stability. On the contrary, interleaving has a risk that competition among the PMEM DIMMs would occur as the number of processes increases and operations would become unstable. Another advantage is that it is possible to cause the PMED DIMMs to function as security countermeasures. For example, separating the PMEM DIMMs physically makes it possible to inhibit side-channel attacks. Furthermore, it is possible to reduce access adverse effects of other processes on the same PMEM DIMM.

The procedure of using a PMEM will be described. A memory mapping system call is called from an application. On receiving a memory map system call, an OS memory maps a file in a virtual address space of the application. The application then directly accesses the file not via the OS according to a load command or a store command.

Thereafter, the application then calls a memory unmapping system call. On receiving the memory unmapping system call, the OS unmaps the file from the virtual address space.

A technique of storing information of the number of times each page is rewritten in a data storage unit in a main memory and smoothing the number of times rewriting is performed in a non-volatile memory DIMM on a page basis has been proposed as a technique of managing a non-volatile memory. Furthermore, a technique of dividing a main memory consisting of a non-volatile memory by a unit of block of a fixed length, managing the number of times rewriting is performed on a block basis, and keeping a block with much rewriting from being used has been proposed.
Patent Literature 1: Japanese Laid-open Patent Publication No. 2013-254357
Patent Literature 2: US Patent Application Publication No. 2013/0282967

When rewriting concentrates on a specific one of a plurality of PMEM DIMMs, the PMEM DIMM on which rewriting concentrates is worn out faster than others. When worn out, an operation, such as replacing the PMEM DIMM, occurs and operating efficiency of the information processing device decreases. As described above, the conventional method of managing PMEM DIMMs has a difficulty in using memories efficiently.

It is thus desirable to smooth accesses to the PMEM DIMMs; however, when the application accesses a PMEM DIMM not via the OS, it is difficult for the software, such as the OS or a file system, to know the number of times the PMEM is rewritten. Thus, the conventional technique for information processing devices in which PMEM DIMMs are installed has difficulty in using memories efficiently.

Furthermore, in the technique of smoothing the numbers of times rewriting is performed in a non-volatile memory DIMM on a page basis, the numbers of times PMEM DIMMs are written are not smoothed and it is difficult to use memories efficiently. In the technique of dividing a main memory consisting of a non-volatile memory by a unit of block of a fixed length, management of the numbers of times the PMEM DIMMs are rewritten on a file basis is not performed and it is difficult to use memories efficiently.

### SUMMARY

According to an aspect of an embodiment, a non-transitory computer-readable recording medium having stored therein an information processing device control program that causes a computer to execute a process includes: acquires acquiring a total number of rewriting times for each module of a persistent memory (PMEM); and acquiring the number of times a specific file is rewritten based on the numbers of times respective pages of the PMEM are rewritten and, transferring, when the number of times the specific file is rewritten is equal to or larger than a transfer threshold, the specific file to a module with a first total number of rewriting times which is smaller than a second total number of rewriting times of a source module in which the specific file is stored.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of a hardware configuration of an information processing device according to an embodiment;

FIG. 2 is a diagram of a hardware configuration illustrating details of a CPU, DRAM DIMMs and PMEM DIMMs;

FIG. 3 is a block diagram of functions relating to PMEM management by an information processing device according to a first embodiment;

FIG. 4 is a diagram for describing a process of monitoring the total number of times rewriting is performed on a PMEM basis according to the first embodiment;

FIG. 5 is a diagram for describing a file transfer process according to the first embodiment;

FIG. 6 is a diagram for describing a page rewriting number-of-times management process;

FIG. 7 is a flowchart of the process of monitoring the total number of times rewriting is performed on a PMEM basis according to the first embodiment;

FIG. 8 is a flowchart of the page rewriting number-of-times management process;

FIG. 9 is a flowchart of the file transfer process according to the first embodiment;

FIG. 10 is a diagram for describing transfer of a plurality of files in a short time in the case where transfer of a plurality of files is not taken into consideration;

FIG. 11 is a block diagram of functions relating to PMEM management by an information processing device according to a second embodiment;

FIG. 12 is a diagram for describing a process of monitoring the total number of times rewriting is performed on a PMEM basis according to the second embodiment;

FIG. 13 is a diagram for describing a process of managing frequency of rewriting of files;

FIG. 14 is a flowchart of a process of calculating frequency of rewriting on a PMEM basis;

FIG. 15 is a flowchart of a file rewriting frequency management process;

FIG. 16 is a flowchart of a file transfer process according to the second embodiment; and

FIG. 17 is a diagram for describing transfer of a plurality of files performed by the information processing device according to the second embodiment.

### DESCRIPTION OF EMBODIMENT

Preferred embodiments of the present invention will be explained with reference to accompanying drawings. The following embodiment does not limit the computer-readable recording medium, the information processing device control method, and the information processing device that are disclosed by the present application.

### [a] First Embodiment

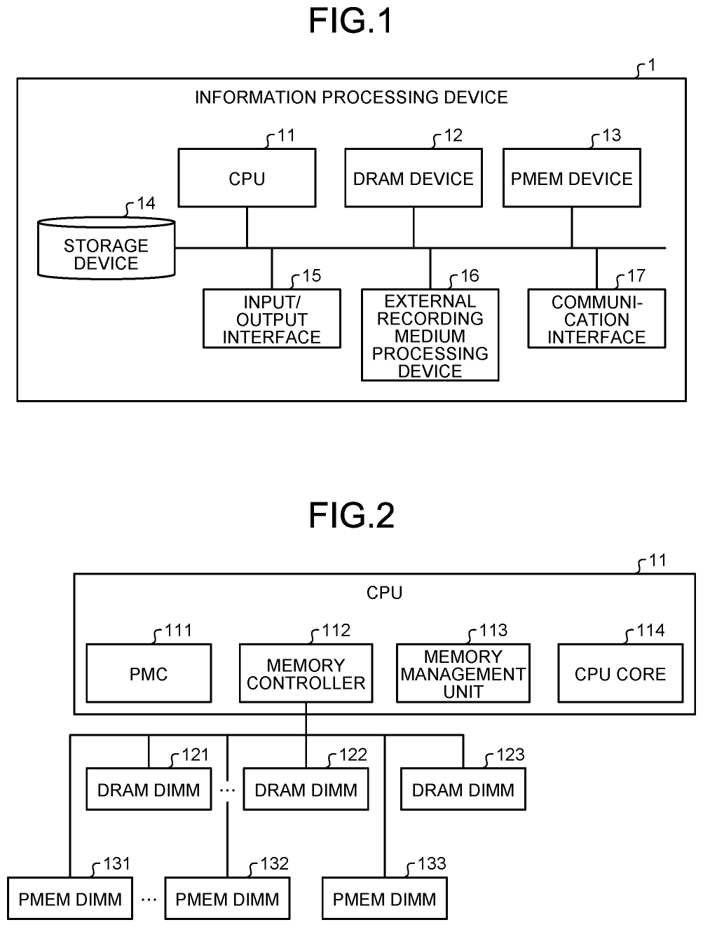

FIG. 1 is a diagram of a hardware configuration of the information processing device according to the embodiment. As illustrated in FIG. 1, an information processing device 1 includes a CPU 11, a DRAM device 12, a PMEM device 13, a storage device 14, an input/output interface 15, an external recording medium processing device 16, and a communication interface 17. The CPU 11 is connected to the DRAM device 12, the PMEM device 13, the storage device 14, the input/output interface 15, the external recording medium processing device 16, and the communication interface 17 via a bus.

The input/output interface 15 is an interface for inputting signals from the outside and outputting signals to the outside. An input device, such as a keyboard or a mouse, and an output device, such as a monitor, are connected to the input/output interface 15. The input/output interface 15 transmits a signal that is input using the input device to the CPU 11 via the bus. The input/output interface 15 transmits a signal on which an instruction to output the signal is issued by the CPU 11 to the output device via the bus to output the signal.

A portable recording medium, such as a compact disk (CD) or a digital versatile disc (DVD), is attachable to the external recording medium processing device 16. The external recording medium processing device 16 reads data from an attached portable recording medium and writes data into the attached portable recording medium.

The communication interface 17 is an interface that relays communications with an external device. For example, the communication interface 17 relays communications between a terminal device of a user of an application that runs on the information processing device 1 and the CPU 11.

The storage device 14 is an auxiliary storage device, such as a hard disk and a solid state drive (SSD). The storage device 14 stores programs for enabling various functions that the information processing device 1 to be described below includes and that will be described below and various programs including an OS and an application.

The DRAM device 12 includes a plurality of DRAM DIMMs. The PMEM device 13 includes a plurality of PMEM DIMMs. Both the DRAM device 12 and the PMEM device 13 run as a main storage device.

The CPU 11 reads the various programs from the storage device 14, loads the programs into the DRAMs of the DRAM device 12 or the PMEMs of the PMEM device 13, and executes the programs. Accordingly, the CPU 11, for example, causes the OS or the application to run. Furthermore, the CPU 11 enables various functions that the information processing device 1 includes and that are described below.

FIG. 2 is a diagram of a hardware configuration illustrating details of a CPU, DRAM DIMMs and PMEM DIMMs.

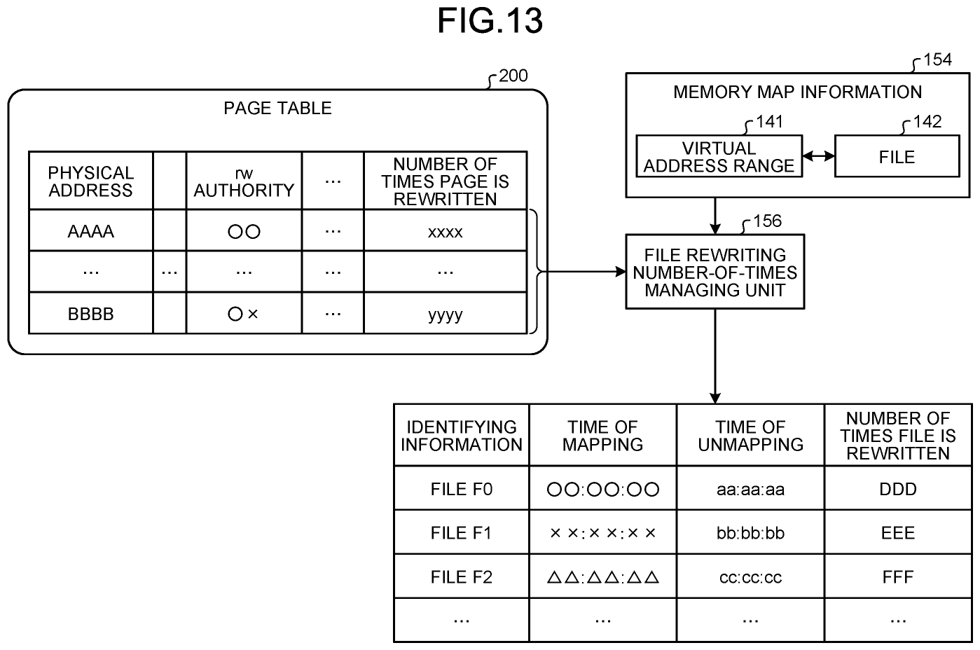

DRAM DIMMs 121 to 123 are included by the DRAM device 12. The DRAM DIMMs 121 to 123 are modules with a plurality of DRAMS installed therein. The PMEM DIMMs 131 to 133 are included by the PMEM device 13 illustrated in FIG. 13. The PMEM DIMMs 131 to 133 are modules with PMEMs installed therein. Each one of the DRAM DIMMs 121 to 123 and the PMEM DIMMs 131 to 133 is installed in a single memory slot (not illustrated in the drawings). Data is written/read by a unit of the DRAM DIMMs 121 to 123 or the PMEM DIMMs 131 to 133. In the present embodiment, the PMEM DIMMs are used without interleaving.

As illustrated in FIG. 2, the CPU 11 includes a PMC 111, a memory controller 112, a memory management unit 113 and a CPU core 114. The DRAM DIMMs 121 to 123 are connected to the memory controller 112. The PMEM DIMMs 131 to 133 are connected to the memory controller 112.

The PMC 111, the memory management unit 133 and the CPU core 114 access the DRAM DIMMs 121 to 123 and the PMEM DIMMs 131 to 133 via the memory controller 112. The CPU core 114 causes the OS and the application to run.

The PMC 111 is a monitoring device that counts the number of events of hardware that are executed. Particularly, the PMC 111 counts the number of times each of the PMEM DIMMs 131 to 133 is rewritten.

The memory management unit 113 is also referred to as a MMU. The memory management unit 113 converts a virtual address that is specified by an application execution unit 102 into a physical address.

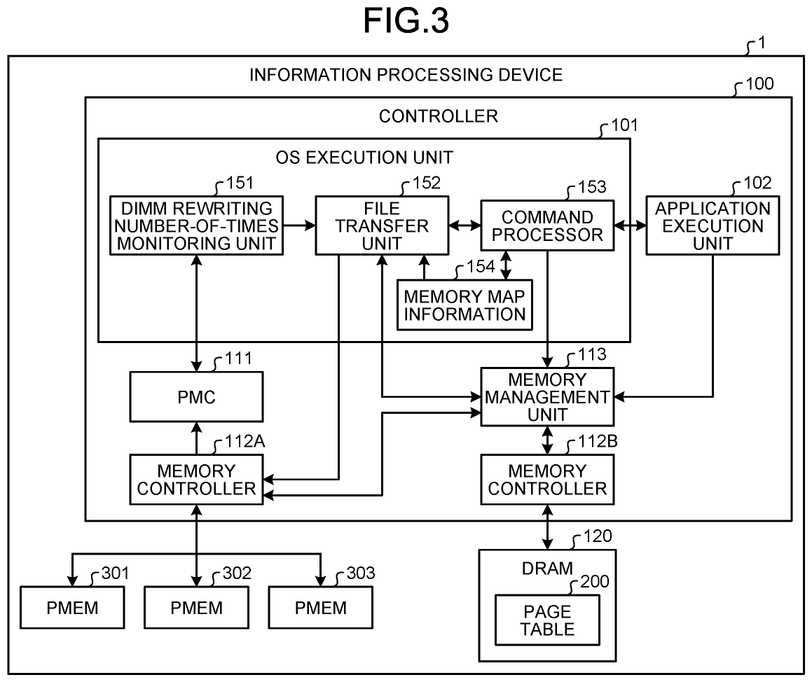

FIG. 3 is a block diagram of functions relating to PMEM management by the information processing device according to a first embodiment. With reference to FIG. 3, PMEM management performed by the information processing device 1 according to the embodiment will be described.

The information processing device 1 includes a controller 100, PMEMs 301 to 303 and a DRAM 120. Functions of the controller 100 are enabled by the CPU 11 that is exemplified in FIG. 1 and FIG. 2. The PMEMs 301 to 303 correspond to the PMEM DIMMs 131 to 133 exemplified in FIG. 2, respectively. In other words, the PMEMs 301 to 303 are DIMMs that are different from one another and interleaving is not performed among the PMEMs 301 to 303. When not distinguished from one another, the PMEMs 301 to 303 are referred to as PMEMs 300 below. The DRAM 120 corresponds to the DRAM DIMMs 121 to 123 that are exemplified in FIG. 2. The DRAM DIMMs 121 to 123 are not distinguished from one another herein and are represented by the DRAM 120.

The DRAM 120 includes a page table 200. The page table 200 is a data structure that is used to associate a virtual address that the OS uses and a physical address in an actual memory.

The controller 100 includes an OS execution unit 101, the application execution unit 102, the PMC 111, memory controllers 112A and 112B, and the memory management unit 113. The memory controllers 112A and 112B correspond to the memory controller 112 in FIG. 1. FIG. 3 presents the PMC 111, the memory controllers 112A and 112B, and the memory management unit 113 by the hardware in FIG. 2 enabling each of the functions. FIG. 3 presents the memory controller 112 as the two memory controllers 112A and 112B for the convenience of description; however, the memory controller 112 may include a single memory controller.

The OS execution unit 101 includes a DIMM rewriting number-of-times monitoring unit 151, a file transfer unit 152, a command processor 153 and memory map information 154. The OS execution unit 101 is enabled by, for example, the CPU core 114.

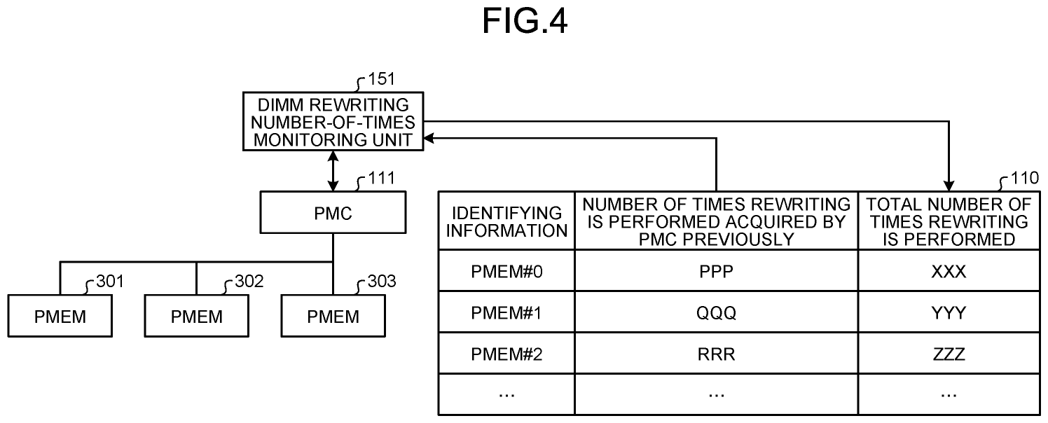

The DIMM rewriting number-of-times monitoring unit 151 monitors each of the PMEMs 300 via the PMC 111 and regularly acquires the total numbers of times the respective PMEMs 300 are rewritten from the PMC 111. The DIMM rewriting number-of-times monitoring unit 151 makes a notification indicating the acquired total numbers of times the respective PMEMs 300 are rewritten in response to an acquisition request from the file transfer unit 152. FIG. 4 is a diagram for describing a process of monitoring the total number of times rewriting is performed on a PMEM basis according to the first embodiment. With reference to FIG. 4, operations of the DIMM rewriting number-of-times monitoring unit 151 will be described. In order to make the description easy to understand, the memory controller 112A is omitted from FIG. 4. Practically, however, the PMC 111 accesses the PMEMs 300 via the memory controller 112A.

The DIMM rewriting number-of-times monitoring unit 151 includes a total rewriting number-of-times management file 110 like that illustrated in FIG. 4. The total rewriting number-of-times management file 110 is a file in which the total numbers of times the respective PMEMs 300 are rewritten, which is statistical information, are rewritten and are managed. The DIMM rewriting number-of-times monitoring unit 151 is able to use the total rewriting number-of-times management file 110 in which nothing is registered as an initial state.

The DIMM rewriting number-of-times monitoring unit 151 regularly issues a request to acquire the numbers of times the respective PMEMs 300 are rewritten to the PMC 111. Thereafter, the DIMM rewriting number-of-times monitoring unit 151 acquires the numbers of times the respective PMEMs 300 are rewritten.

The DIMM rewriting number-of-times monitoring unit 151 then acquires the previously-acquired number of times rewriting is performed from the total rewriting number-of-times management file 110. When the total rewriting number-of-times management file 110 is in an initial state, the DIMM rewriting number-of-times monitoring unit 151 may acquire 0 as the previously-acquired number of times rewriting is performed.

The DIMM rewriting number-of-times monitoring unit 151 then subtracts the previously-acquired numbers of times rewriting is performed from the currently-acquired numbers of times the respective PMEMs 300 are rewritten, respectively. Thereafter, the DIMM rewriting number-of-times monitoring unit 151 adds the respective calculated differences to the respective previously-acquired total numbers of times the respective PMEMs 300 are rewritten, thereby calculating the total numbers of times the respective PMEMs 300 are rewritten. Thereafter, the DIMM rewriting number-of-times monitoring unit 151 overwrites the information of the total rewriting number-of-times management file 110 with the calculated numbers of times the respective PMEMs 300 are rewritten, thereby updating the information.

The number of the PMCs 111 that can be arranged in the CPU 11 is limited physically. For this reason, each PMC 111 may count different events by the same counter. In other words, the counter value is reset when the event is switched. As described above, there is a possibility that the PMC 111 is reset and, in some cases, the total number of times each PMEM is rewritten is not counted. For this reason, the DIMM rewriting number-of-times monitoring unit 151 according to the embodiment calculates the total number of times rewriting is performed previously by adding the difference from the previous count value to the previous total number of times rewriting is performed.

Note that, when it is possible to have the specific PMC 111 be fixed for the number of times the specific PMEM 300 is rewritten, the DIMM rewriting number-of-times monitoring unit 151 is able to use the counter value directly as the total number of times rewriting is performed without the above-described calculation. In this case, use of the specific PMC 111 to count other events is restricted.

Furthermore, the DIMM rewriting number-of-times monitoring unit 151 further receives a request to acquire the total numbers of times the respective PMEMs 300 are rewritten from the file transfer unit 152. The DIMM rewriting number-of-times monitoring unit 151 acquires information of the total numbers of times the respective PMEMs 300 are rewritten that are registered in the total rewriting number-of-times management file 110 and outputs the information to the file transfer unit 152.

To memory unmap a file that is mapped in a virtual address space, the file transfer unit 152 knows the numbers of times the respective pages corresponding to a virtual address range of the file to be unmapped and acquires the number of times the file is rewritten. When the number of times the file is rewritten exceeds a given transfer threshold, the file transfer unit 152 transfers the file to the PMEM 300 with the smallest number of times rewriting is performed. Accordingly, the file transfer unit 152 is able to smooth the numbers of times rewriting is performed among the PMEMs. Details of the file transfer unit 152 will be described below.

The file transfer unit 152 receives a notification on start of memory unmapping from the command processor 153. When memory unmapping a file that is mapped in a virtual address space, the file transfer unit 152 acquires a virtual address range in which unmapping is performed in the virtual address space from the command processor 153.

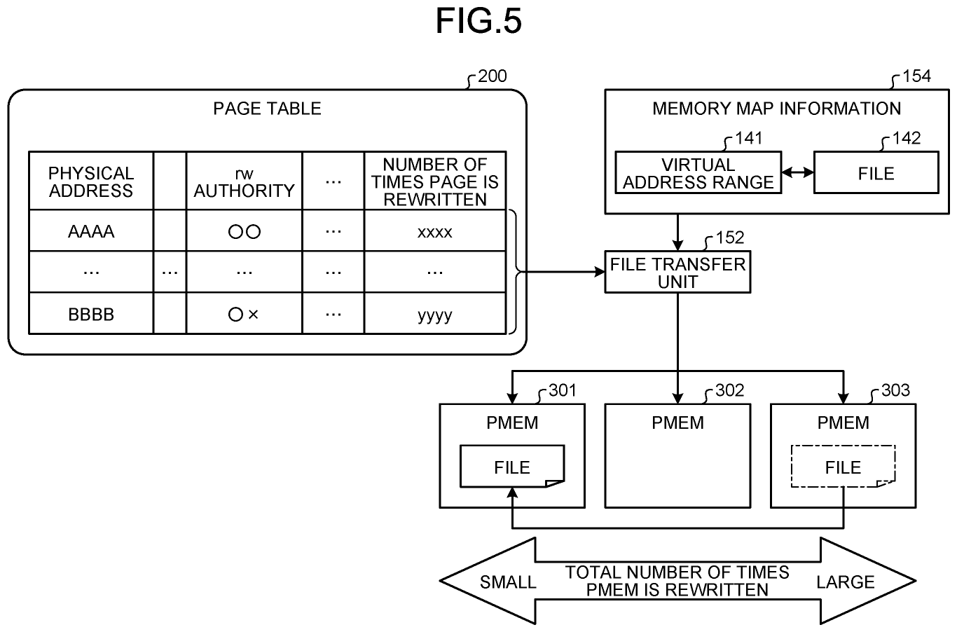

FIG. 5 is a diagram for describing a file transfer process according to the first embodiment. With reference to FIG. 5, operations of the file transfer unit 152 will be described. In FIG. 5, the memory controller 112A is omitted for easy understanding of the description. Practically, however, the PMC 111 accesses the PMEMs 300 via the memory controller 112A. As illustrated in FIG. 5, the file transfer unit 152 refers to the memory map information 154 and acquires a file name of a file 142 corresponding to a virtual address range 141. The file name is used for the following file transfer.

The file transfer unit 152 issues a request to acquire the number of times each page in the virtual address range 141 is rewritten, which is registered in the page table 200, to the memory management unit 113. Details of the page table 200 will be described below. Thereafter, the file transfer unit 152 acquires information of the numbers of times the respective pages having physical addresses corresponding to the virtual address range 141 from the memory management unit 113. The numbers of times the respective pages are rewritten corresponds to an example of the numbers of times respective pages are rewritten.

The file transfer unit 152 sums the acquired numbers of times the respective pages are rewritten, thereby calculating the total number of times the file is rewritten. The file transfer unit 152 then determines whether the calculated total number of times rewriting is performed is equal to or larger than the predetermined transfer threshold.

When the total number of times rewriting is performed is smaller than the predetermined transfer threshold, the file transfer unit 152 notifies the command processor 153 of execution of memory unmapping. The file transfer unit 152 then ends the process of file transfer between the PMEMs 300.

On the other hand, when the total number of times rewriting is performed is equal to or larger than the predetermined transfer threshold, the file transfer unit 152 issues a request to acquire the total numbers of times the respective PMEMs 300 are rewritten to the DIMM rewriting number-of-times monitoring unit 151. Thereafter, the file transfer unit 152 acquires information of the total numbers of times the respective PMEMs 300 are rewritten from the DIMM rewriting number-of-times monitoring unit 151.

The file transfer unit 152 then extracts the total number of times the PMEM 300 in which the file that is a subject of determination is arranged. Thereafter, the file transfer unit 152 determines whether the total number of times the PMEM 300 in which the file that is the subject of determination is arranged is the smallest among the total numbers of times the respective PMEMs 300 are rewritten. When the total number of times the PMEM 300 in which the file that is the subject of determination is arranged is the smallest, there is no PMEM 300 to which the file is to be transferred and therefore the file transfer unit 152 notifies the command processor 153 of execution of memory unmapping and ends the process of file transfer between the PMEMs 300.

On the other hand, when the total number of times the PMEM 300 in which the file that is the subject of determination is arranged is not the smallest, the file transfer unit 152 specifies the PMEM 300 with the smallest total number of times rewriting is performed. The file transfer unit 152 then transfers the file that is the subject of determination to the specified PMEM 300. Thereafter, the file transfer unit 152 notifies the command processor 153 of permission of execution of memory unmapping and ends the process of file transfer between the PMEMs 300.

For example, the case where, as illustrated in FIG. 5, the PMEM 301, the PMEM 302, and the PMEM 303 have the total numbers of times rewriting is performed in the descending order will be described. In this case, for example, the file transfer unit 152 determines that the file that is the subject of determination is arranged in the PMEM 303. The file transfer unit 152 confirms that the total number of times the PMEM 303 in which the file that is the subject of determination is arranged is rewritten is not the smallest. The file transfer unit 152 then specifies the PMEM 301 as the PMEM 300 with the smallest number of times rewriting is performed. The file transfer unit 152 then transfers the file that is stored in the PMEM 303 to the PMEM 301. This transfer is practically performed by the memory controller 112A that receives the instruction from the file transfer unit 152. The file transfer unit 152 notifies the command processor 153 of execution of memory unmapping and ends the process of file transfer between the PMEMs 300.

The command processor 153 executes various types of processes by the OS other than the process performed by the DIMM rewriting number-of-times monitoring unit 151 and the file transfer unit 152. For example, the command processor 153 processes a memory mapping system call or a memory unmapping system call that is sent out of the application execution unit 102. The command processor 153 receives a call of a memory mapping system call from the application execution unit 102. The command processor 153 maps a file in a virtual memory space that is allocated to an application. At that time, the command processor 153 generates the memory map information 154 that associates a memory range that is allocated to the file and information on the file. Thereafter, the command processor 153 notifies the application execution unit 102 of the address of the virtual memory space in which the file is mapped.

Thereafter, when a memory access process ends, the command processor 153 receives a call of a memory unmapping system call from the application execution unit 102. The command processor 153 notifies the file transfer unit 152 of the start of memory unmapping. Thereafter, on receiving a permission to execute memory unmapping, the command processor 153 unmaps the file from the virtual address space.

The application execution unit 102 causes applications to run to execute various processes by the respective applications and, in association with execution of the processes, starts a process of accessing the PMEMs 300. The application execution unit 102 calls for a memory mapping system call to the command processor 153 of the OS execution unit 101. Thereafter, the application execution unit 102 receives a notification indicating an address of a virtual memory space in which a file is mapped from the command processor 153. The application execution unit 102 issues an instruction to directly write or read data in or from the memory mapped file to the memory management unit 113 using the address of the virtual address space of the notification. Thereafter, when the memory access process ends, the application execution unit 102 calls for a memory unmapping system call to the command processor 153.

The PMC 111 regularly receives a request to acquire the numbers of times the respective PMEMs 300 are rewritten from the DIMM rewriting number-of-times monitoring unit 151. The PMC 111 acquires the numbers of times the respective PMEMs 300 are rewritten via the memory controller 112A. The PMC 111 provides a response of the acquired numbered of times the respective PMEMs 300 are rewritten to the DIMM rewriting number-of-times monitoring unit 151.

The memory management unit 113 receives an instruction of memory mapping from the command processor 153. The memory management unit 113 acquires physical addresses of the PMEMs 300 corresponding to the memory range of virtual addresses specified in memory mapping via the memory controller 112A. The memory management unit 113 generates a conversion table presenting correspondence between the virtual addresses of the notification and ensured physical addresses and stores the conversion table.

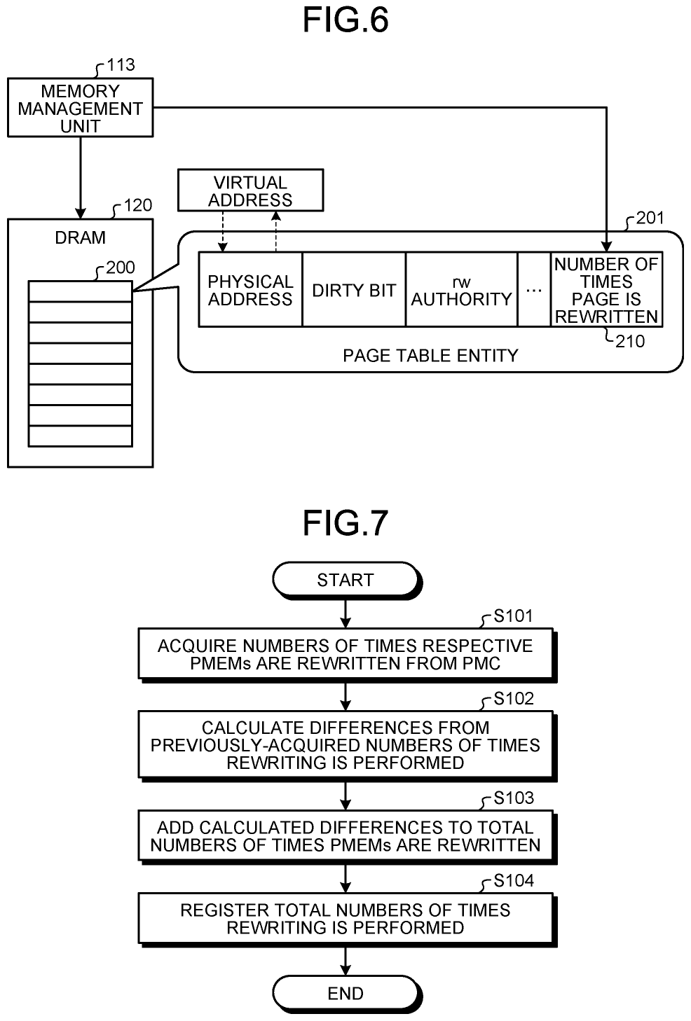

The memory management unit 113 manages the numbers of times respective pages of the PMEM 300 are rewritten and notifies the file transfer unit 152 of the numbers of times the respective pages in the virtual address range are rewritten in memory unmapping. FIG. 6 is a diagram for describing a page rewriting number-of-times management process. With reference to FIG. 6, the page rewriting number-of-times management process performed by the memory management unit 113 will be described.

The memory management unit 113 stores the page table 200 in the DRAM 120. The page table 200 includes a page table entity (PET) 201 in which information on each page is registered on a page basis. In each page table entity 201, as illustrated in FIG. 6, a physical address, a dirty bit, and a rw (read write) authority of each page are stored. Furthermore, in the present embodiment, the memory management unit 113 registers a page rewriting number-of-times 210 in the page table entity 201. The page rewriting number-of-times 210 is the total number of times the page corresponding to the page table entity 201 is rewritten.

The memory management unit 113 receives a request to access a virtual address from the application execution unit 102. The memory management unit 113 then acquires a physical address corresponding to the virtual address using the conversion table. When the access command that is received from the application execution unit 102 is a command to write in the PMEM 300, the memory management unit 113 increments the number of times a page is rewritten in the page table entity 201 corresponding to the page for writing. The memory management unit 113 then outputs the acquired physical address to the command processor 153.

On receiving a command to access the PMEM 300 from the application execution unit 102, the memory management unit 113 writes or read data in or from the PMEM 300 via the memory controller 112A using the physical address according to the command. Thereafter, the memory management unit 113 outputs the process result to the application execution unit 102.

The memory management unit 113 receives a request to acquire the numbers of times respective pages in the virtual address range registered in the page table 200 are rewritten from the file transfer unit 152. The memory management unit 113 acquires the physical addresses corresponding to the virtual address range from the conversion table. The memory management unit 113 refers to the page rewriting number-of-times 210 in the page table entity 201 corresponding to each page contained in the virtual address range from the page table 200 that the DRAM 120 stores via the memory controller 112B. The memory management unit 113 then acquires the numbers of times the respective pages contained in the virtual address range are rewritten from the page table 200. The memory management unit 113 then outputs information of the numbers of times the respective pages in the virtual address range are rewritten to the file transfer unit 152. Thereafter, on receiving an instruction of memory unmapping from the command processor 153 that executes the OS, the memory management unit 113 releases the physical addresses of the PMEMs 300 or the DRAMs 120 in association with the virtual addresses.

In the embodiment, the numbers of times the pages are rewritten are stored in the page table 200; however, the numbers of times the pages are rewritten may be stored in another mode. For example, the numbers of times may be stored in a region of the DRAM 120, the storage device 14, the inside of the CPU 11, or the inside of the PMEM 300 other than the page table 200. Note that, when the numbers of times are stored in the region of the DRAM 120 other than the page table 200, a counter is searched using software, such as the OS. In this case, search at a low rate by software is performed. On the other hand, using the page table 200 enables search at a high rate by the memory management unit 113, which makes it possible to shorten the time of process. Furthermore, using the storage device 14 takes time to access and is thus not practical. When the numbers of times are stored inside the CPU 11, the area of the CPU 11 is strictly restricted and it is difficult to keep the space for placing a counter. When the numbers of times are stored inside the PMEM 300, using a physical rewritable counter for wear leveling is considered; however, accessing the counter is difficult and thus is not practical. From the above-described circumstances, the configuration in which the numbers of times the pages are rewritten are stored in the page table 200 is employed in the embodiment.

On receiving an instruction to acquire the numbers of times rewriting is performed from the PMC 111, the memory controller 112A accesses each of the PMEMs 300 and acquires the numbers of times rewriting is performed. The memory controller 112A accesses each of the PMEMs 300 of the acquisition and notifies the PMC 111 of the numbers of times rewriting is performed.

On receiving an instruction from the memory management unit 113, the memory controller 112A ensures the regions of the PMEMs 300 and notifies the memory management unit 113 of the physical addresses of the ensured regions. Thereafter, according to instructions from the memory management unit 113, the memory controller 112A executes a process of writing or reading data in or from the PMEMs 300.

The memory controller 112B receives a request to acquire the number of times each page in the virtual address range that is registered in the page table 200 from the memory management unit 113. The memory controller 112B acquires the numbers of times the respective specified pages are rewritten from the page table 200 that the DRAM 120 stores. Thereafter, the memory controller 112B outputs the numbers of times the respective pages in the virtual address range are rewritten to the memory management unit 113.

FIG. 7 is a flowchart of the process of monitoring the total number of times rewriting is performed on a PMEM basis according to the first embodiment. With reference to FIG. 7, a flow of the process of monitoring the total numbers of times the respective PMEMs 300 are rewritten, which is performed by the DIMM rewriting number-of-times monitoring unit 151, will be described next.

The DIMM rewriting number-of-times monitoring unit 151 outputs a request to acquire the numbers of times the PMEMs 300 are rewritten to the PMC 111. Thereafter, the DIMM rewriting number-of-times monitoring unit 151 acquires the numbers of times the respective PMEMs 300 are rewritten from the PMC 111 (step S101).

The DIMM rewriting number-of-times monitoring unit 151 then acquires the previously-acquired numbers of times rewriting is performed from the total rewriting number-of-times management file 110. The DIMM rewriting number-of-times monitoring unit 151 calculates differences between the respective currently-acquired numbers of times the respective PMEMs 300 are rewritten and the previously-acquired numbers of times the respective PMEMs 300 are rewritten (step S102).

The DIMM rewriting number-of-times monitoring unit 151 then adds the respective differences corresponding to the previously-calculated respective total numbers of times the respective PMEMs 300 are rewritten (step S103).

Thereafter, the DIMM rewriting number-of-times monitoring unit 151 registers the calculated differences as the total numbers of times the respective PMEMs 300 are rewritten in the total rewriting number-of-times management file 110 and updates the total rewriting number-of-times management file 110 (step S104).

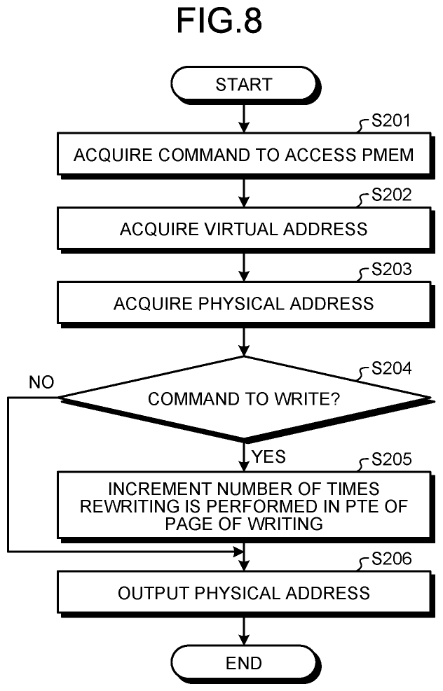

FIG. 8 is a flowchart of the page rewriting number-of-times management process. With reference to FIG. 8, a flow of the page rewriting number-of-times management process performed by the memory management unit 113 will be described next.

The memory management unit 113 acquires a command to access the PMEM 300 from the application execution unit 102 (step S201).

The memory management unit 113 acquires a virtual address that is specified by the access command (step S202).

The memory management unit 113 then converts the virtual address that is acquired using the conversion table into a physical address, thereby acquiring a physical address to access (step S203).

The memory management unit 113 then determines whether the access command is a write command (step S204). When the access command is not a write command (NO at step S204), the page rewriting number-of-times management process proceeds to step S206.

On the other hand, when the access command is a write command (YES at step S204), the memory management unit 113 increments the number of times rewriting is performed in PTE of the page table entity 201 of the page of writing in the page table 200 (step S205).

Thereafter, the memory management unit 113 outputs the physical address to the command processor (step S206).

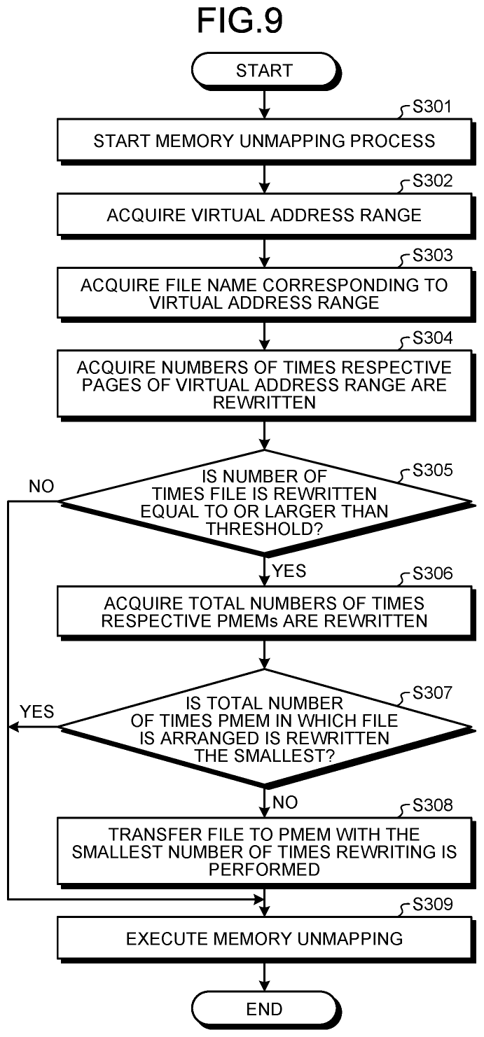

FIG. 9 is a flowchart of the file transfer process according to the first embodiment. With reference to FIG. 9, the file transfer process performed by the file transfer unit 152 will be described next.

The command processor 153 that executes the OS starts a memory unmapping process (step S301). The file transfer unit 152 receives a notification of the start of the memory unmapping process from the command processor 153.

The file transfer unit 152 acquires a virtual address range of the PMEM 300 to be unmapped from the command processor 153 that executes the OS (step S302).

The file transfer unit 152 refers to the memory map information 154 and acquires a file name corresponding to the acquired virtual address range (step S303).

The file transfer unit 152 acquires the numbers of times the respective pages corresponding to the virtual address range are rewritten from the memory management unit 113 (step S304).

The file transfer unit 152 sums the numbers of times the respective pages corresponding to the virtual address range are rewritten, thereby calculating the number of times the file is rewritten. The file transfer unit 152 then determines whether the number of times the file is rewritten is equal to or larger than the predetermined transfer threshold (step S305). When the number of times the file is rewritten is smaller than the transfer threshold (NO at step S305), the file transfer process proceeds to step S309.

On the other hand, when the number of times the file is rewritten is equal to or larger than the transfer threshold (YES at step S305), the file transfer unit 152 acquires the total numbers of times the respective PMEMs 300 are rewritten from the DIMM rewriting number-of-times monitoring unit 151 (step S306).

The file transfer unit 152 then determines whether the total number of times the PMEM 300 in which the file is arranged is rewritten is the smallest among the total numbers of times the respective PMEMs 300 are rewritten (step S307). When the total number of times the PMEM 300 in which the file is arranged is rewritten is the smallest (YES at step S307), the file transfer process proceeds to step S309.

On the other hand, when the total number of times the PMEM 300 in which the file is arranged is rewritten is not the smallest (NO at step S307), the file transfer unit 152 transfers the file to the PMEM 300 with the smallest total number of times rewriting is performed (step S308).

Thereafter, the file transfer unit 152 notifies the command processor 153 of a permission to execute memory unmapping. On receiving the permission from the file transfer unit 152, the command processor 153 executes memory unmapping (step S309).

As described above, in the information processing device according to the embodiment, the OS acquires the numbers of times the respective PMEM are rewritten via the PMC and calculates the respective total numbers of times rewriting is performed. In memory unmapping, the OS acquires the number of times each page is rewritten via the memory management unit and calculates the number of times the file is rewritten and, when the number of times rewriting is performed is equal to or larger than the transfer threshold, determines that the frequency of rewriting the file is high and transfers the file to the PMEM with the smallest total number of times rewriting is performed.

Accordingly, the information processing device is able to smooth the frequency of rewriting on a PMEM DIMM basis. In other words, concentration of rewriting enables inhibition of occurrence of an event that a specific PMEM DIMM is worn out earlier than others. Accordingly, it is possible to use memories efficiently. Using the file to be unmapped as a subject of rewriting makes the data transfer process easy and makes it possible to easily smooth the frequency of rewriting on a PMEM DIMM basis.

### Second Embodiment

An information processing device according to a second embodiment will be described. In the first embodiment, while frequency of rewriting on a PMEM DIMM basis is smoothed by transferring files one by one, transfer of a plurality of files is not taken into consideration. When a plurality of files are transferred in a short time, files with a large number of times the file is rewritten would probably be transferred in a concentrative manner to the same specific PMEM DIMM. In that case, wearing out of the PMEM DIMM to which the files are transferred tends to occur.

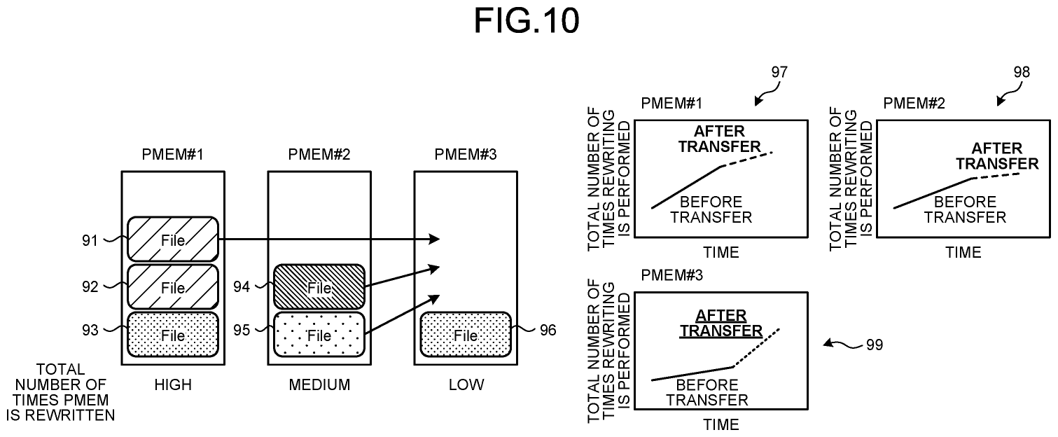

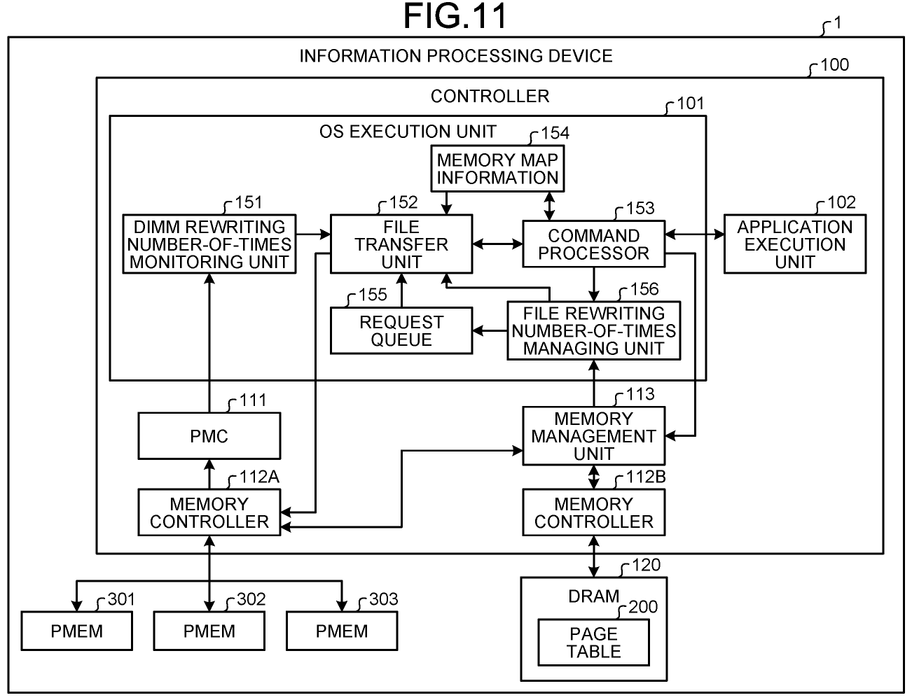

FIG. 10 is a diagram for describing transfer of a plurality of files in a short time in the case where transfer of a plurality of files is not taken into consideration. For example, the case in which there are PMEM DIMMs that are PMEM #1 to PMEM #3 will be described.

The total number of times PMEM #1 is rewritten is large, the total number of times PMEM #2 is rewritten is medium, and the total number of times PMEM #3 is rewritten is small. In PMEM #1, the numbers of times a file 91 and a file 92 are rewritten are equal to or larger than a transfer threshold and the number of times a file 93 is rewritten is smaller than the transfer threshold. In PMEM #2, the numbers of times a file 94 and a file 95 are rewritten are equal to or larger than the transfer threshold. In PMEM #3, the number of times a file 96 is rewritten is smaller than the transfer threshold.

In this case, the files 91 and 92 of PMEM #1 are transferred to PMEM #3 with the smallest total number of times rewriting is performed. The files 94 and 95 of PMEM #2 are transferred to PMEM #3 with the smallest total number of times rewriting is performed, too.

When such transfer is performed, changes in the total numbers of times the respective PMEMs PMEM #1 to PMEM #3 are rewritten are represented by Graphs 97 to 99. In each of Graphs 97 to 99, the vertical axis represents the total number of times rewriting is performed and the horizontal axis represents elapse of time. In Graphs 97 to 99, the slope represents a trend of increase in the total number of times rewriting is performed, that is, change in frequency of rewriting. As represented in Graphs 97 and 98, because of transfer of the files, the frequency of rewriting of PMEM #1 and PMEM #2 lowers after the transfer. On the other hand, the frequency of rewriting of PMEM #3 significantly increases because of the transfer corresponding to the decrease in frequency of rewriting of PMEM #1 and PMEM #2. In this case, the possibility that wearing out of PMEM #3 would occur increases.

FIG. 11 is a block diagram of functions relating to PMEM management by the information processing device according to the second embodiment. The information processing device 1 according to the second embodiment performs processing as follows in order to inhibit concentration of transfer of files on a destination of transfer. The information processing device 1 collectively transfers a plurality of files that are unmapped within a given period. For transfer, the information processing device 1 according to the second embodiment acquires frequency of rewriting of files per unit of time at the time of unmapping. The information processing device 1 according to the embodiment transfers files to each PMEM 300 such that the difference in trend of increase in the total number of times rewriting is performed among the PMEMs 300.

Details of the information processing device 1 will be described below. As illustrated in FIG. 11, the information processing device 1 according to the second embodiment includes a request queue 155 and a file rewriting number-of-times managing unit 156 in addition to each of the units described in the first embodiment. In the following description, the same units and functions as those of the first embodiment would be omitted below.

The DIMM rewriting number-of-times monitoring unit 151 calculates frequency of rewriting of each of the PMEMs 300 in addition to the total number of times each of the PMEMs 300 is rewritten. An operation of the DIMM rewriting number-of-times monitoring unit 151 will be described specifically.

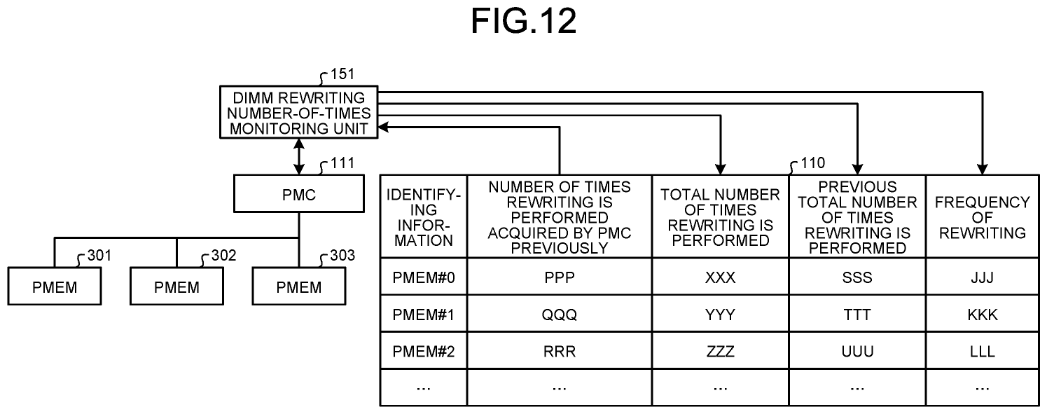

FIG. 12 is a diagram for describing a process of monitoring the total number of times rewriting is performed on a PMEM basis according to the second embodiment. The DIMM rewriting number-of-times monitoring unit 151 according to the second embodiment includes the total rewriting number-of-times management file 110 illustrated in FIG. 12. The total rewriting number-of-times management file 110 according to the second embodiment contains information containing the previous total numbers of times rewriting is performed and frequency of rewriting in addition to information on the numbers of times rewriting is performed and the total numbers of times rewriting is performed that are acquired previously by the PMC 111.

The DIMM rewriting number-of-times monitoring unit 151 regularly acquires the numbers of times the respective PMEMs 300 are rewritten from the PMC 111. The DIMM rewriting number-of-times monitoring unit 151 then acquires the previously-acquired numbers of times rewriting is performed from the total rewriting number-of-times management file 110. The DIMM rewriting number-of-times monitoring unit 151 then subtracts the previously-acquired numbers of times rewriting is performed from the currently-acquired numbers of times the respective PMEMs 300 are rewritten, respectively, thereby calculating differences. Thereafter, the DIMM rewriting number-of-times monitoring unit 151 adds the respective calculated differences to the respective previously-acquired total numbers of times the respective PMEMs 300 are rewritten, thereby calculating new total numbers of times the respective PMEMs 300 are rewritten. Thereafter, the DIMM rewriting number-of-times monitoring unit 151 overwrites the information of the total rewriting number-of-times management file 110 with the calculated total numbers of times the respective PMEMs 300 are rewritten, thereby updating the information.

The DIMM rewriting number-of-times monitoring unit 151 calculates, with respect to each of the PMEMs 300, a difference between the previous total number of times rewriting is performed and the current total number of times rewriting is performed. The DIMM rewriting number-of-times monitoring unit 151 then divides the calculated difference by a time from the time at which the previous total number of times rewriting is performed is calculated to the time at which the current total number of times rewriting is performed is calculated, thereby calculating frequency of rewriting per unit of time with respect to each of the PMEMs 300. The DIMM rewriting number-of-times monitoring unit 151 then registers information on the calculated frequency of rewriting of each of the PMEMs 300 in the total rewriting number-of-times management file 110. The DIMM rewriting number-of-times monitoring unit 151 registers the information on the calculated current total numbers of times rewriting is performed in the column of the previous total number of times rewriting is performed in the total rewriting number-of-times management file 110.

Back to FIG. 11, description will be continued. The file rewriting number-of-times managing unit 156 manages transfer requests to transfer of unmapped files and manages the number of times each file stored in each of the PMEMs 300 is rewritten. Operations of the file rewriting number-of-times managing unit 156 will be described specifically.

FIG. 13 is a diagram for describing a process of managing frequency of rewriting of files. The file rewriting number-of-times managing unit 156 includes a file rewriting frequency management table 400 illustrated in FIG. 13. In the file rewriting frequency management table 400, with respect to each file, the time at which the file is mapped, the time at which the file is unmapped, and the number of times the file is rewritten from the mapping until the unmapping are registered.

The file rewriting number-of-times managing unit 156 receives a notification on start of memory mapping from the command processor 153. The file rewriting number-of-times managing unit 156 then acquires a virtual address range in which mapping is performed in a virtual address space from the command processor 153. The file rewriting number-of-times managing unit 156 then acquires identifying information on the file corresponding to the virtual address range in which mapping is performed from a correspondence relationship between the virtual address range 141 and the file 142 that are registered in the memory map information 154. The file rewriting number-of-times managing unit 156 registers the time at which the file is mapped in the file rewriting frequency management table 400.

The file rewriting number-of-times managing unit 156 receives a notification on start of memory unmapping from the command processor 153. The file rewriting number-of-times managing unit 156 then acquires a virtual address range in which unmapping is performed in a virtual address space from the command processor 153. The file rewriting number-of-times managing unit 156 then acquires identifying information on the file corresponding to the virtual address range in which unmapping is performed from a correspondence relationship between the virtual address range 141 and the file 142 that are registered in the memory map information 154.

The file rewriting number-of-times managing unit 156 issues a request to acquire the number of times each page in the virtual address range is rewritten, which is registered in the page table 200, to the memory management unit 113. Thereafter, as illustrated in FIG. 13, the file rewriting number-of-times managing unit 156 acquires information of the numbers of times the respective pages having physical addresses corresponding to the virtual address range, which are registered in the page table 200, from the memory management unit 113. The file rewriting number-of-times managing unit 156 then adds up the acquired numbers of times the respective pages are rewritten on a file basis, thereby calculating the number of times each unmapped file is rewritten. Thereafter, the file rewriting number-of-times managing unit 156 registers the number of times each file is rewritten in a mapping time from the mapping until the unmapping in the file rewriting frequency management table 400. The file rewriting number-of-times managing unit 156 further registers the times at which the files are unmapped in the file rewriting frequency management table 400.

In the second embodiment, the file rewriting number-of-times managing unit 156 acquires the virtual address range that is a subject of mapping processing at the time of both mapping and unmapping. Alternatively, information that is acquired at the time of mapping may be stored and used at the time of unmapping.

Thereafter, the file rewriting number-of-times managing unit 156 stores a request to transfer the unmapped file in the request queue 155. As described above, transfer of the file is not performed at the time of unmapping and the request is stored as a transfer request in the request queue 155 until the file transfer unit 152 performs a file transfer process.

Back to FIG. 11, the description will be continued. The file rewriting number-of-times managing unit 156 calculates the number of times each unmapped file is rewritten and therefore the file transfer unit 152 according to the second embodiment need not perform those processes. Regularly, the file transfer unit 152 sequentially acquires the transfer requests that are stored in the request queue 155. On every acquisition of a transfer request, the file transfer unit 152 executes the following process. A file that is specified by a transfer request that is acquired by the file transfer unit 152 is referred to as “transfer subject file” below.

The file transfer unit 152 acquires the time at which a transfer subject file is mapped, the time at which the transfer subject file is unmapped, and the number of times the file is rewritten from the file rewriting frequency management table 400 that the file rewriting number-of-times managing unit 156 stores. The file transfer unit 152 then determines whether the number of times the transfer subject file is rewritten is equal to or larger than a transfer threshold. When the number of times the transfer subject file is rewritten is smaller than the transfer threshold, the file transfer unit 152 does not transfer the transfer subject file and moves to processing of the next transfer request.

On the other hand, when the number of times the transfer subject file is rewritten is equal to or larger than the transfer threshold, the file transfer unit 152 calculates a mapping time of the transfer subject file from the time at which the file is mapped until the time at which the file is unmapped from the time of mapping and the time of unmapping. The file transfer unit 152 then divides the number of times the file is rewritten by the mapping time, thereby calculating frequency of rewriting of the transfer subject file during that time.

The file transfer unit 152 then acquires the frequency of rewriting of each of the PMEMs 300 from the total rewriting number-of-times management file 110 that the DIMM rewriting number-of-times monitoring unit 151 stores. Using the frequency of rewriting of the transfer subject file and the frequency of rewriting of each of the PMEMs 300, the file transfer unit 152 determines the PMEM 300 to which the transfer subject file is to be transferred such that the difference in frequency of rewriting among the PMEMs 300 is minimized.

For example, the case where there are the PMEMs 301 to 303 and the PMEM 301 stores a transfer subject file will be described. The file transfer unit 152 chooses the PMEM 302 from among the PMEMs other than the PMEM 301 storing the transfer subject file. The file transfer unit 152 then estimates frequency of rewriting of each of the PMEMs 301 and 303 in the case where the transfer subject file is transferred from the PMEM 301 to the PMEM 302. Specifically, the file transfer unit 152 estimates frequency of rewriting of the PMEM 301 after the transfer by subtracting the frequency of rewriting of the transfer subject file from the frequency of rewriting of the PMEM 301. The file transfer unit 152 estimates frequency of rewriting of the PMEM 302 after the transfer by adding the frequency of rewriting of the transfer subject file to the frequency of rewriting of PMEM 302. The file transfer unit 152 estimates that the frequency of rewriting of the PMEM 303 is maintained after the transfer. Similarly, the file transfer unit 152 chooses the PMEM 303 and estimates frequency of rewriting of each of the PMEMs 301 and 303 in the case where the transfer subject file is transferred from the PMEM 301 to the PMEM 303. The file transfer unit 152 estimates frequency of rewriting of each of the PMEMs 301 and 303 in the current state as frequency of rewriting of each of the PMEMs 301 and 303 in the case where the transfer subject file is not transferred.

Thereafter, the file transfer unit 152 calculates a maximum value of the difference in frequency of rewriting between the PMEMs 301 and 303 in each case and determines a destination of transfer in the case where the maximum value is the smallest as the PMEM 300 to which the transfer subject file is to be transferred.

Thereafter, the file transfer unit 152 transfers the transfer subject file to the PMEM 300 that is determined as the destination of transfer. When the PMEM 300 that is determined as the destination of transfer is the PMEM 300 from which the transfer subject file is to be transferred, the file transfer unit 152 does not transfer the transfer subject file.

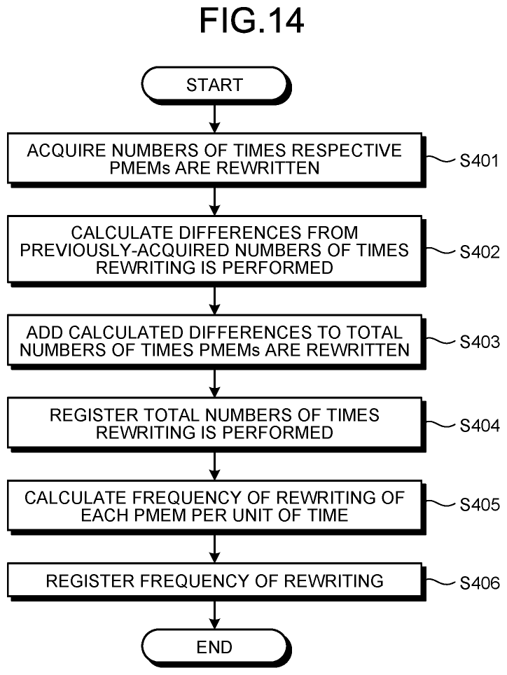

FIG. 14 is a flowchart of a process of calculating frequency of rewriting on a PMEM basis. With reference to FIG. 14, a flow of the process of calculating frequency of rewriting of each of the PMEMs 300.

The DIMM rewriting number-of-times monitoring unit 151 outputs a request to acquire the numbers of times the respective PMEMs 300 are rewritten to the PMC 111. Thereafter, the DIMM rewriting number-of-times monitoring unit 151 acquires the numbers of times the respective PMEMs 300 are rewritten from the PMC 111 (step S401).

The DIMM rewriting number-of-times monitoring unit 151 then acquires the previously-acquired numbers of times rewriting is performed from the total rewriting number-of-times management file 110. The DIMM rewriting number-of-times monitoring unit 151 calculates differences between the respective currently-acquired numbers of times the respective PMEMs 300 are rewritten and the previously-acquired numbers of times the respective PMEMs 300 are rewritten (step S402).

The DIMM rewriting number-of-times monitoring unit 151 then adds the respective differences corresponding to the previously-calculated respective total numbers of times the respective PMEMs 300 are rewritten (step S403).

Thereafter, the DIMM rewriting number-of-times monitoring unit 151 registers the calculated differences as the total numbers of times the respective PMEMs 300 are rewritten in the total rewriting number-of-times management file 110 and updates the total rewriting number-of-times management file 110 (step S404).

The DIMM rewriting number-of-times monitoring unit 151 calculates, with respect to each of the PMEMs 300, a difference between the previous total number of times rewriting is performed and the current total number of times rewriting is performed. The DIMM rewriting number-of-times monitoring unit 151 then divides the calculated difference by a time from the time at which the previous total number of times rewriting is performed is calculated until the time at which the current total number of times rewriting is performed is calculated, thereby calculating frequency of rewriting of each of the PMEMs 300 (step S405).

Thereafter, the DIMM rewriting number-of-times monitoring unit 151 registers information on the calculated frequency of rewriting of each of the PMEMs 300 in the total rewriting number-of-times management file 110 (step S406). The DIMM rewriting number-of-times monitoring unit 151 also registers information on the calculated current total number of times rewriting is performed in the column of the previous total number of times rewriting is performed in the total rewriting number-of-times management file 110.

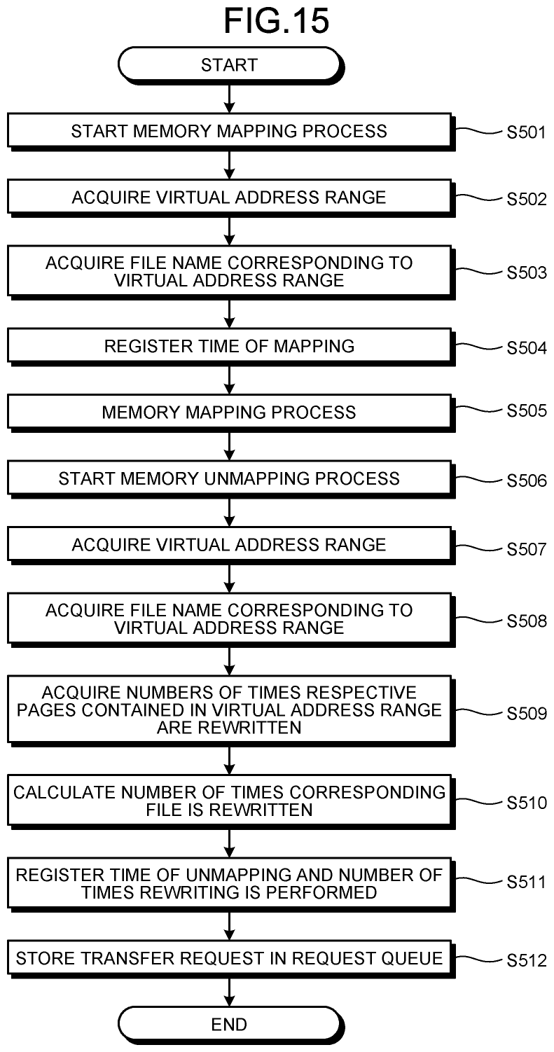

FIG. 15 is a flowchart of a file rewriting frequency management process. With reference to FIG. 15, a flow of the file rewriting frequency management process will be described.

The command processor 153 starts a memory mapping process (step S501). The file rewriting number-of-times managing unit 156 receives a notification on start of the memory unmapping process from the command processor 153.

The file rewriting number-of-times managing unit 156 then acquires a virtual address range in which mapping is performed in the virtual address space from the command processor 153 (step S502).

The file rewriting number-of-times managing unit 156 then acquires a file name of a file corresponding to the virtual address range (step S503).

The file rewriting number-of-times managing unit 156 then registers the time of mapping in the column of the file corresponding to the virtual address range in the file rewriting frequency management table 400 (step S504).

The command processor 153 executes the memory mapping process (step S505). Once the memory mapping process completes, the command processor 153 starts a memory unmapping process (step S506). The file rewriting number-of-times managing unit 156 receives a notification of the start of the memory unmapping process from the command processor 153.

The file rewriting number-of-times managing unit 156 then acquires a virtual address range in which unmapping is performed in the virtual address space from the command processor 153 (step S507)

The file rewriting number-of-times managing unit 156 then acquires a file name of a file corresponding to the virtual address range (step S508).

The file rewriting number-of-times managing unit 156 then acquires the numbers of times the respective pages contained in the virtual address range are rewritten from the page table 200 (step S509).

The file rewriting number-of-times managing unit 156 then sums the numbers of times the respective pages are rewritten, thereby calculating the number of times the corresponding file is rewritten (step S510).

The file rewriting number-of-times managing unit 156 then registers the time of unmapping of the corresponding file and the number of times the file is rewritten in the file rewriting frequency management table 400 (step S511).

Furthermore, the file rewriting number-of-times managing unit 156 stores a request to transfer the corresponding file in the request queue 155 (step S512).

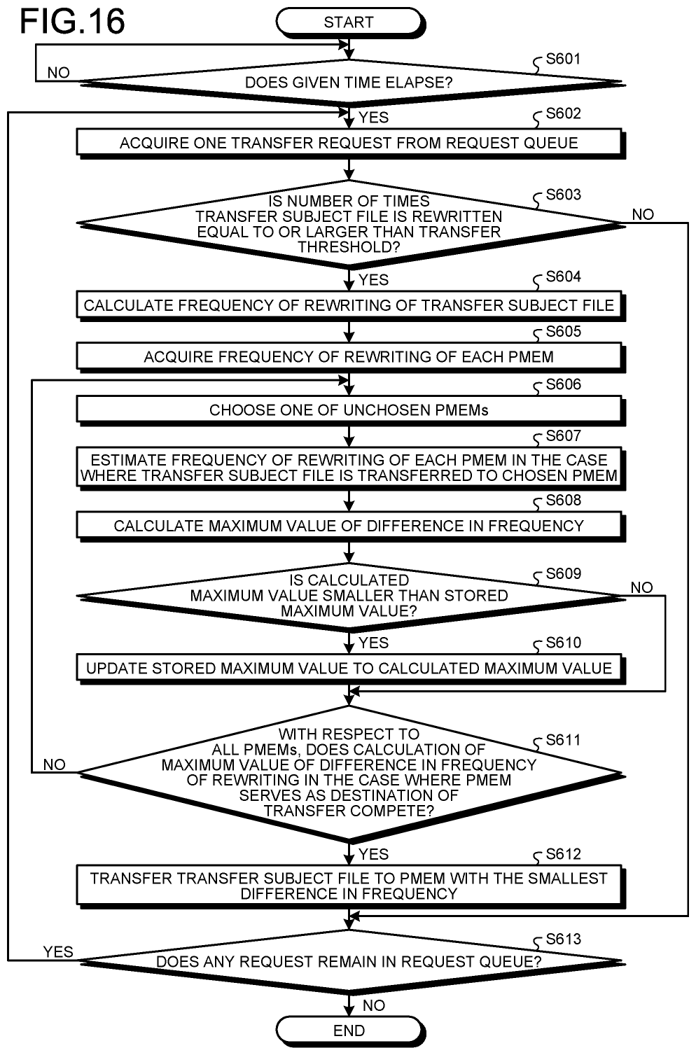

FIG. 16 is a flowchart of a file transfer process according to the second embodiment. The file transfer process according to the second embodiment will be descried with reference to FIG. 16.

The file transfer unit 152 determines whether a given time elapses from the previous file transfer process (step S601). When the given time does not elapse (NO at step S601), the file transfer unit 152 waits until the given time elapses.

On the other hand, when the given time elapses (YES at step S601), the file transfer unit 152 acquires one transfer request from the request queue 155 (step S602).

The file transfer unit 152 then acquires the time at which a transfer subject file is mapped, the time at which the transfer subject file is unmapped, and the number of times the file is rewritten from the file rewriting frequency management table 400 that the file rewriting number-of-times managing unit 156 stores. The file transfer unit 152 then determines whether the number of times the transfer subject file is rewritten is equal to or larger than a transfer threshold (step S603). When the number of times the transfer subject file is rewritten is smaller than the transfer threshold (NO at step S603), the file transfer unit 152 moves to step S613.

On the other hand, when the number of times the transfer subject file is rewritten is equal to or larger than the transfer threshold (YES at step S603), the file transfer unit 152 calculates a mapping time from the time at which the file is mapped until the time at which the file is unmapped from the time of mapping and the time of unmapping. The file transfer unit 152 then divides the number of times the file is rewritten by the mapping time, thereby calculating frequency of rewriting of the transfer subject file during that time (step S604).

The file transfer unit 152 then acquires the frequency of rewriting of each of the PMEMs 300 from the total rewriting number-of-times management file 110 that the DIMM rewriting number-of-times monitoring unit 151 stores (step S605).

The file transfer unit 152 chooses one of unchosen PMEMs 300 (step S606).

The file transfer unit 152 then estimates frequency of rewriting of each of the PMEMs 300 in the case where the transfer subject file is transferred to the chosen PMEM 300 (step S607).

Using the estimated frequency of rewriting of each of the PMEMs 300, the file transfer unit 152 calculates a maximum value of the difference in frequency of rewriting among the PMEMs 300 (step S608).

The file transfer unit 152 then determines whether the calculated maximum value of the difference in frequency of rewriting is smaller than a maximum value of the difference in frequency of rewriting that is stored (step S609). When there is no maximum value of the difference in frequency of rewriting that is already calculated, the file transfer unit 152 determines that the calculated maximum value of the difference in frequency of rewriting is smaller than the stored maximum value of the difference in frequency of rewriting.

When the calculated maximum value of the difference in frequency of rewriting is equal to or larger than the maximum value of the difference in frequency of rewriting (NO at step S609), the file transfer unit 152 goes to step S611.

On the other hand, when the calculated maximum value of the difference in frequency of rewriting is smaller than the stored maximum value of the difference in frequency of rewriting (YES at step S609), the file transfer unit 152 updates the stored maximum value of the difference in frequency of rewriting to the calculated maximum value of the difference in frequency of rewriting (step S610).

Thereafter, the file transfer unit 152 determines, with respect to all the PMEMs 300, whether calculation of a maximum value of the difference in frequency of rewriting in the case where the PMEM 300 serves as a destination of transfer completes (step S611). When there remains a PMEM 300 that is not chosen as a destination of transfer in calculation of a maximum value of the difference in frequency of rewriting (NO at step S611), the file transfer unit 152 returns to step S606.

On the other hand, when, with respect to all the PMEMs, calculation of a maximum value of the difference in frequency of rewriting in the case where the PMEM 300 serves as a destination of transfer completes (YES at step S611). The file transfer unit 152 determines the PMEM 300 with the smallest difference in frequency of rewriting as the destination of transfer. The file transfer unit 152 then transfers the transfer subject file to the PMEM 300 that is determined as the destination of transfer (step S612).

Thereafter, the file transfer unit 152 determines whether there remains any transfer request in the request queue 155 (step S613). When there remains a transfer request in the request queue 155 (YES at step S613), the file transfer unit 152 returns to step S602. On the other hand, when there remains no transfer request in the request queue 155 (NO at step S613), the file transfer unit 152 ends the file transfer process.

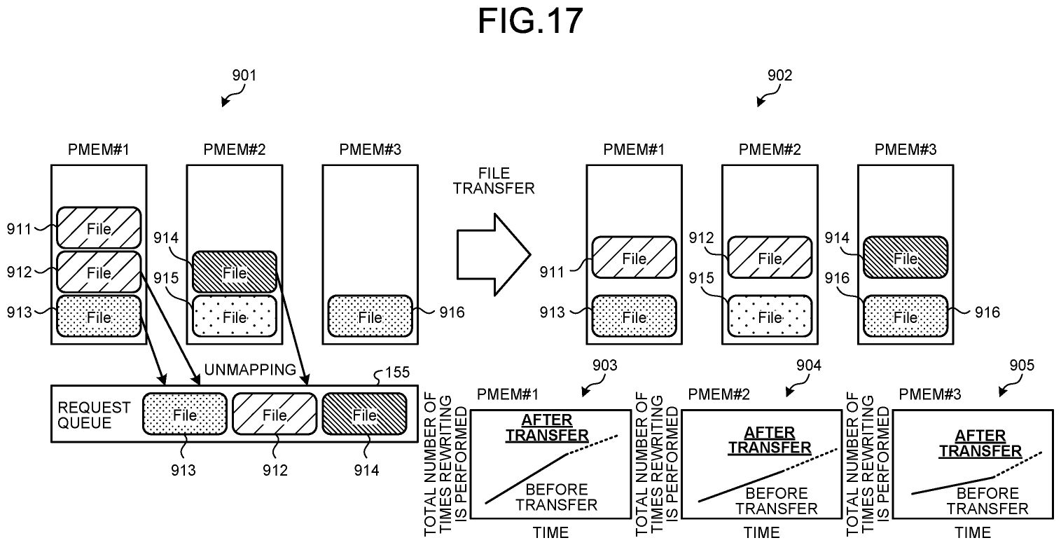

FIG. 17 is a diagram for describing transfer of a plurality of files performed by the information processing device according to the second embodiment. With reference to FIG. 17, an overview of transfer of a plurality of files performed by the information processing device 1 according to the second embodiment will be collectively described.

For example, the case where there are PMEMs PMEM #1 to PMEM #3 as the PMEMs 300 will be described. As presented by a state 901, PMEM #1 includes files 911 to 913. PMEM #2 includes files 914 and 915. PMEM #3 includes a file 916. In the state 901, when the mapping process is performed and the files 914, 912 and 913 are unmapped sequentially in this order, requests to transfer the files 914, 912 and 913 are stored in this order in the request queue 155. In FIG. 17, the transfer requests are represented by the files 914, 912 and 913 for easy understanding.

In this case, the information processing device 1 acquires the request to transfer the file 914, determines PMEM #3 as a destination of transfer from estimation of frequency of rewriting of each of the PMEMs 300 and transfers the file 914 to PMEM #3. The information processing device 1 acquires the request to transfer the file 912, determines PMEM #2 as a destination of transfer from estimation of frequency of rewriting of each of the PMEMs 300 and transfers the file 912 to PMEM #2. The information processing device 1 acquires the request to transfer the file 913 and does not transfer the file 913 because the number of times the file 913 is rewritten is smaller than the transfer threshold. Accordingly, each of PMEMs PMEM #1 to PMEM #3 after execution of the file transfer process enters a state 902.

Changes in the total numbers of times PMEMs PMEM #1 to PMEM #3 are rewritten, respectively, are represented by Graphs 903 to 905. In this case, compared to the case illustrated in FIG. 10 where transfer of a plurality of files is not taken into consideration, the slopes representing frequency of rewriting of PMEMs PMEM #1 to PMEM #3 are gentle and the difference in the number of times rewriting is performed between the PMEMs is small. Thus, compared to the case where transfer of a plurality of files are not taken into consideration, the information processing device 1 according to the second embodiment enables equalization of the numbers of times respective PMEMs PMEM #1 to PMEM #3 are rewritten.

As described above, the information processing device according to the second embodiment collectively transfers a plurality of files that are rewritten often. When transferring files, the information processing device according to the second embodiment calculates frequency of rewriting of files in a mapping time and estimates frequency of rewriting on a PMEM DIMM basis after transfer of the files from the calculated frequency of rewriting of the files and frequency of rewriting on a PMEM DIMM basis. Thereafter, the information processing device according to the second embodiment determines a destination of transfer such that the difference in frequency of rewriting is at minimum among PMEM DIMMs and sequentially transfer each file.

Thus, when transfer of a plurality of files occurs in a short time, the information processing device according to the second embodiment is able to inhibit occurrence of wearing out because of concentration of transfer of files on a specific PMEM DIMM. Accordingly, it is possible to equalize frequency of rewriting of PMEM DIMMs, that is, the pace of wearing out and inhibit a specific PMEM DIMM from wearing out.

According to one aspect, the present disclosure enables efficient use of memories.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein an information processing device control program that causes a computer to execute a process comprising:
acquiring a total number of rewriting times for each module of a persistent memory (PMEM); and
acquiring the number of times a specific file is rewritten based on the numbers of times respective pages of the PMEM are rewritten and transferring, when the number of times the specific file is rewritten is equal to or larger than a transfer threshold, the specific file to a module with a first total number of rewriting times which is smaller than a second total number of rewriting times of a source module in which the specific file is stored.

2. The non-transitory computer-readable recording medium according to claim 1, wherein the process further comprises calculating the total number of rewriting times for the each module based on statistical information which is obtained from a monitoring device configured to count the number of events occurring in the each module.

3. The non-transitory computer-readable recording medium according to claim 1, wherein the process further comprises:
acquiring a virtual address range which is allocated to the specific file in a virtual address space;
acquiring the numbers of times the respective pages with physical addresses corresponding to the virtual address range are rewritten from a memory management unit which processes a memory access request; and
acquiring the number of times the specific file is rewritten by summing the acquired numbers of times the respective pages are rewritten.

4. The non-transitory computer-readable recording medium according to claim 1, wherein the process further comprises transferring the specific file when the specific file is unmapped from the virtual address space.

5. The non-transitory computer-readable recording medium according to claim 1, wherein the process further comprises transferring the specific file to the module with the smallest total number of rewriting times.

6. An information processing device control method comprising:
acquiring the total number of rewriting times for each module of a persistent memory (PMEM);
acquiring the number of times a specific file is rewritten based on the numbers of times respective pages of the PMEM are rewritten and, when the number of times the specific file is rewritten is equal to or larger than a transfer threshold, transferring the specific file to a module with a first total number of rewriting times which is smaller than a second total number of rewriting times of a source module in which the specific file is stored.

7. An information processing device comprising:
a rewriting number-of-times monitoring unit that acquires a total number of rewriting times for each module of a persistent memory (PMEM); and
a file transfer unit that acquires the number of times a specific file is rewritten based on the numbers of times respective pages of the PMEM are rewritten and that transfers, when the number of times the specific file is rewritten is equal to or larger than a transfer threshold, the specific file to a module with a first total number of rewriting times which is smaller than a second total number of rewriting times of a module in which the specific file is stored.

8. The non-transitory computer-readable recording medium according to claim 1, wherein the process further comprises calculating first frequency of rewriting of the specific file based on the number of times the specific file is rewritten, calculating second frequency of rewriting of the each module based on the number of times the each module is rewritten, and, based on the first frequency of rewriting and the second frequency of rewriting, determining the module to which the specific file is to be transferred such that a difference in frequency of rewriting among the modules is small.

9. The non-transitory computer-readable recording medium according to claim 8, wherein the process further comprises:
when a file is unmapped from a virtual address space, storing a transfer request to transfer the file in a request queue; and
repeating sequentially choosing the transfer requests that are stored in the request queue in a given period one by one and transferring the file that is specified by the chosen transfer request as the specific file.

10. The information processing device control method according to claim 6, further comprising calculating first frequency of rewriting of the specific file based on the number of times the specific file is rewritten, calculating second frequency of rewriting of the each module based on the number of times the each module is rewritten, and, based on the first frequency of rewriting and the second frequency of rewriting, determining the module to which the specific file is to be transferred such that a difference in frequency of rewriting among the modules is small.

11. The information processing device according to claim 7, wherein the file transfer unit calculates first frequency of rewriting of the specific file based on the number of times the specific file is rewritten, calculates second frequency of rewriting of the each module based on the number of times the each module is rewritten, and, based on the first frequency of rewriting and the second frequency of rewriting, determines the module to which the specific file is to be transferred such that a difference in frequency of rewriting among the modules is small.
